(19) United States
(12) Patent Application Publication
(10) Pub. No.: US 2020/0051054 A1
(43) Pub. Date: Feb. 13, 2020

(54) METHOD AND APPARATUS FOR CREDIT TRANSACTION EMPLOYING UNBREAKABLE ENCRYPTION

(71) Applicant: Qwyit LLC, Oak Hill, VA (US)

(72) Inventor: R. Paul McGough, Manassas, VA (US)

(73) Assignee: Qwyit LLC, Oak Hill, VA (US)

(21) Appl. No.: 16/295,560

(22) Filed: Mar. 7, 2019

Related U.S. Application Data
(60) Provisional application No. 62/639,737, filed on Mar. 7, 2018.

(51) Int. Cl. G06Q 20/24; G06F 8/60; G06F 21/45; H04L 9/08; G06Q 40/02; G06Q 20/40; G06Q 20/38

(52) U.S. Cl. CPC G06Q 20/24; G06F 8/60; G06F 21/45; H04L 63/061; G06Q 40/025; G06Q 20/4012; G06Q 20/382; H04L 9/0894

(57) ABSTRACT

A method and apparatus for a streamlined electronic credit transaction that provides more security in a streamlined transaction process than any current deferred net settlement system. The removal of the physical credit card restores the proper risk balance to all participants and performs processing in real time, faster than any current system. The method relies on secure authentication and encryption security communications, based on the provably secure unbreakable mathematics of underdetermined systems of equations, which are maintained everywhere throughout the transaction process.

### RELATED APPLICATIONS

This application claims priority to U.S. Provisional Patent Application filed Mar. 7, 2018 by the same inventor with the same title.

The present application is related to the following patents and patent applications: U.S. patent application Ser. No. 08/879,708 filed Jun. 20, 1997 (now U.S. Pat. No. 6,058,189, which issued May 2, 2000) entitled “Method and System for Performing Secure Electronic Monetary Transactions;”

U.S. patent application Ser. No. 08/923,095 filed Sep. 4, 1997 (now U.S. Pat. No. 6,002,769, which issued Dec. 14, 1999) entitled “Method and System for Performing Secure Electronic Messaging,” which claimed the benefit of U.S. patent application Ser. No. 08/879,708;

U.S. patent application Ser. No. 09/212,294 filed Dec. 16, 1998 (now U.S. Pat. No. 6,445,797, which issued Sep. 3, 2002) entitled “Method and System for Performing Secure Electronic Digital Streaming;”

U.S. patent application Ser. No. 10/062,312 filed Feb. 1, 2002 entitled “Method and System for Performing Perfectly Secure Key Exchange and Authenticated Messaging;”

U.S. Provisional Application No. 60/563,065 filed Apr. 16, 2004;

U.S. patent application Ser. No. 11/108,347 filed Apr. 18, 2005 entitled “Method and System for Performing Perfectly Secure Key Exchange and Authenticated Messaging,” which claimed the benefit of U.S. patent application Ser. No. 10/062,312 and U.S. Provisional Application No. 60/563,065;

U.S. Provisional Application No. 60/842,595 filed Sep. 6, 2006;

U.S. patent application Ser. No. 11/850,948 filed Sep. 6, 2007 (now U.S. Pat. No. 7,899,185, which issued Mar. 1, 2011) entitled “Real privacy management authentication system,” which application claimed the benefit of U.S. Provisional Application No. 60/842,595;

U.S. patent application Ser. No. 11/899,741 filed Sep. 6, 2007 (now U.S. Pat. No. 8,144,874), which issued Mar. 27, 2012 and is entitled “Method for Obtaining Key for use in Secure Communications over a Network and Apparatus for Providing Same,” which application claimed the benefit of U.S. Provisional Application No. 60/842,595;

U.S. patent application Ser. No. 11/899,742 filed Sep. 6, 2007 (now U.S. Pat. No. 8,144,875), which issued Mar. 27, 2012 and is entitled “Method and System for Establishing Real-Time Authenticated and Secured Communications Channels in a Public Network,” which application claimed the benefit of U.S. Provisional Application No. 60/842,595;

U.S. patent application Ser. No. 13/430,253 filed Mar. 26, 2012 (now U.S. Pat. No. 8,649,520), which issued Feb. 11, 2014 and is entitled “Method and System for RealTime Trust in a Public Network,” which application in turn claimed priority to U.S. patent application Ser. No. 11/899,742; and

U.S. patent application Ser. No. 14/176,284 filed Feb. 10, 2014, entitled “Method and System for Establishing Real-Time Trust in a Public Network” which claimed priority to U.S. patent application Ser. No. 13/430,253.

U.S. Provisional Patent Application No. 62/532,095 filed Jul. 13, 2017 entitled “Method and Apparatus for Authentication and Encryption Service.”

All of the foregoing patents and patent applications are hereby incorporated by reference, including the drawings, as if repeated herein in their entirety.

### BACKGROUND

The present invention relates generally to methods and apparatuses for performing credit transactions, and more particularly to a method and apparatus for performing a credit transaction between a merchant and a customer at a point of sale in an electronic or paperless manner.

Generally, electronic credit payments should work just like a cash transaction. The consumer gets his stuff, the merchant says pay this amount which includes tax, and the consumer gives the merchant the money—there no is swiping, no signing, nothing: the customer simply hands over the cash and is done. This is all any merchant wants and needs: no fee cash payments—even if they are electronic.

As usual in this digital world, the ‘experts’ have completely mucked everything up: the focus of a credit transaction has been bullied by credit card companies with skyrocketing costs and mumbo-jumbo technology that merchants and consumers must use just for the convenience of paying without cash. Is it not time to re-focus the entire credit checkout event back to where it belongs?

The entirety of credit transaction processing is getting more complex for the consumer, more expensive and complicated for the merchant and has an unbalanced risk/reward/cost basis for the financial institutions. There is a great need for a streamlined, transparent, secure and balanced risk/reward system with straightforward, easy to understand simplicity for all users.

This is evidenced by the continual ‘upgrade’ and introduction of more and more new systems that do not solve the problem. These new systems introduce further difficulty, cost, required expertise and pain for all participants without ever reaching the goal: A transparent, understandable, provably secure, fast, no cost credit transaction processing system with equal, shared risk for all participants.

The present invention is therefore directed to the problem of developing a method and apparatus for performing credit transactions that mimics cash transactions and which is completely transparent, understandable, secure, fast, extremely low cost, and with equal, shared risk between all the parties.

### SUMMARY OF THE INVENTION

The present invention—termed QwyitCash℠—is the first and only truly secure, unbreakable, simple and convenient digital monetary transaction—without a single, costly device required. Thus, the present invention enables a customer to walk up to the checkout counter, the clerk tells you the amount, and the customer electronically pays without having to ‘connect’ to anything at the register. The customer only needs a smart phone or other similar ubiquitous device. The customer has a QwyitCash app on the smart phone, the merchant has QwyitCash software running on its web-based point of sale register and both servers of both parties' banks employ similar applications.

The present invention eliminates forever-being-stolen credit cards to swipe, no Near Field Communication dots to wave your phone at, no easily-forged fingerprint biometrics to maneuver, absolutely no devices required—and none of those costs. QwyitCash works just like—better than—cash. Clerk announces the amount, you ‘hand over’ the money, out the door with your stuff.Just.Like.Cash. There is absolutely no requirement for any financial bank to use the complicated, complex, insecure and costly credit transaction of today's credit card processors and associations—along with their cards. Or even the new ‘no-card-but-still-a-reader’ payments like Apple Pay™. It's time for a change. No cards, no readers—just a provably secure credit payment.

The present invention is as safe as a cash transaction. Actually, safer than cash, which can be (and routinely is) counterfeited. The missing ingredient in every processing attempt at securing an electronic credit transaction thus far has been the failure to use a transparent, 100% mathematically unsolvable process (i.e., unbreakable) that positively ties the consumer to the transaction (the loan) and the two banks together (merchant and issuer) so they can authorize, clear and settle payment. All of the really costly new processes that are in use anywhere globally are less than perfect; and they keep getting more complicated without solving the problem.

What it takes is a provable mathematic method used in an impenetrable credit exchange process from you to your lender and back to the merchant. QwyitCash is Better Than Money because it is the first and only exchange combination of secure math (based on provably unsolvable underdetermined equation sets) in an impenetrable process (the merchant-lender-buyer connection happens exterior to the register and is provably, transparently safe). Not only is all the risk mitigated for all parties, it can't be counterfeited, and the setup cost is zero, thus the transaction cost can be very low.

Here are some major advantages:
There are NO physical device requirements at checkout (none of the costs);
There are NO consumer credit cards (Credit Card and their processors are no longer needed—along with all that cost);
NO startup costs for all participants;
Free to all consumers, transaction costs to merchants and financial institutions is very low;
Provably secure—mathematically proven to be unbreakable;
Consumer phone can be lost without risk, merchant registers can be tapped without risk;
QwyitCash future transactions can be given from consumer/merchant/bank to another consumer just like cash—e.g., exactly as a Gift Card but without the physical card from the merchant or bank, and just like cash from person-to-person!

### Problems With Existing Payment Systems

Here's a short list of the problems:
The transaction processes are too complicated, too expensive, too slow, too intrusive;
They require constant update (new cards, new software, new readers, etc.);
They are based on theoretical security, not provable math;
They cost a bundle to initiate, to maintain, to use, to replace;
The per transaction fees are exorbitant;
They are continually and newly exploited (biometrics are fatally flawed (need a new eyeball?), NFC is easily defeated by theft, Chip and Pin have MITM susceptibilities, etc.)

In summary, here's how you know the current stuff isn't working: they keep changing it and telling you more secure, easier, faster, etc. It's either secure, fast, simple, transparent, flexible and final or it's not—tending toward secure just doesn't cut it!

Here's an example of a final, works-all-the-time system: credit card numbers! A perfect system worked out with mathematic precision that dictates what is and what is not a real credit card number. The credit transaction deserves perfection—and it's finally here:

QwyitCash—Better Than Money℠—the first, only and finally perfect credit transaction system.

### QwyitCash Solution

Provide QwyitCash to consumers, merchants and financial institutions. QwyitCash is a provably secure mathematic method used in an impenetrable credit transaction process between you, a merchant, and both party's banks.

QwyitCash is Better Than Money because it is the first and only transaction exchange that uses 100% secure math, based on provably unsolvable underdetermined equation sets, in an impenetrable process where the merchant-banks-buyer connection happens exterior to the register and is provably, transparently safe. All risk is mitigated for all parties, the process is provably secure and all participants except consumers a very low transaction, without any initial costs. Consumers pay no costs whatsoever.

Consumers are required to have a smart phone running the quick QwyitCash download application—over 50% of the credit population has a cell phone, and well over 90% of those are smart phones. Merchants will install any of the multi-platform supported QwyitCash APIs to perform a QwyitCash transaction through their POS software. Lenders will install the same available QwyitCash API to operate on their servers for consideration and decision on each transaction (authorization/denial, clearing and settlement).

QwyitCash no longer requires any consumer to have a physical credit card, and merchants no longer require the use of card readers of any kind.

It is noted here that provably secure and unbreakable means:
The mathematics used is unsolvable other than brute force investigation of the entire possibility range and that takes essentially forever; and
The entire possible range of each and every process step outcome is limited to a known range of results that are effectively handled by all the participants without monetary loss.

The following is a list of many of the advantages in the QwyitCash network of participants, including Consumers, Merchants and financial institutions. Some are particular to just one participant type (e.g., consumer phones), and none of these can be matched by any of the current credit processing systems, technologies and/or networks:
Zero startup costs for all participants;
Works online, in store, restaurants—everywhere a financial institution can make a momentary credit authorization and settlement (deferred net settlement transactions);
Very Low Cost per transaction (Free to consumers);
100% mathematic unbreakable transactional security;
Transparent, impenetrable process security;
QwyitCash client/server software uses provably secure inter-group network communications;
There are NO physical device requirements at checkout (no further associated costs/requirements);
There are NO cards required to be given to consumers (no more Credit Cards and there are no further associated costs/requirements);
QwyitCash future transactions can be given from consumer/merchant/lender to another consumer just like cash—e.g., exactly as a Gift Card but without the physical card from the merchant or lender, and just like cash from person-to-person!;
Phone can be lost/stolen without any risk—QwyitCash can't be used by a thief;
Merchant POS can be openly tapped without any risk—QwyitCash can't be thwarted, replicated, forged, or violated in any way;
Telephone transactions no longer need to communicate card numbers, info;
Quick and easy transaction cancel;
Easily multilingual;
Easy handicapped support for deaf/blind consumers;
Complete transactional flexibility without any security, speed or other impact—e.g., new inter-network participation easily added/changed/updated (for whatever reason—extended credit from multiple parties, commercial requirements, etc.) without process degradation because of QwyitTalk's performance and capabilities; and
Straightforward multiplatform APIs for integration into any POS/server software.

### BRIEF DESCRIPTION OF THE DRAWINGS

FIG. 1 depicts and exemplary embodiment of a method for performing a registration with a central system to enable future credit transactions for consumers, merchants, banks and credit issuers.

FIG. 2 depicts and exemplary embodiment of a method for performing a credit transaction between a consumer and merchant and the interaction between them and the central system, as well as the bank and credit issuer.

FIG. 3 depicts and exemplary embodiment of a method for performing a gift giving transaction for a consumer and the interaction with the central system and credit issuer.

FIG. 4 depicts and exemplary embodiment of a method for performing a gift redemption transaction for a consumer and the interaction with the central system, the merchant, the bank and the credit issuer.

FIG. 5 depicts a diagram of the transaction processing for approval and settlement of the two major credit card associations, Visa® and MasterCard®.

FIGS. 6-9 depict exemplary embodiments of the authentication and encryption protocol used in the embodiments herein.

### DETAILED DESCRIPTION

The present invention enacts and processes a financial credit transaction between parties, generally a merchant (seller) and a consumer (buyer). “QwyitCash” refers to all parts of the protocol, including the incorporation of the QwyitTalk stream cipher and Qwyit authentication.

The complete QwyitCash protocol includes authentication key management through the Qwyit Directory Server system.

Introduction

The present invention, termed QwyitCash, is a provably secure unbreakable mathematic method used in a streamlined, secure credit transaction process between a Consumer, a Merchant, and both party's banks. QwyitCash relies on the communication security of the Qwyit protocol's method. Qwyit is a one-pass embedded symmetric key authentication method, based on underdetermined equation sets, and includes the world's fastest, most secure stream cipher for data encryption (QwyitTalk). QwyitCash is an extension of Qwyit's provably secure cryptographic primitives resulting in a provably secure transaction process. QwyitCash is the first and only fully transparent, understandable, secure,unbreakable, fast, no cost credit transaction processing system with equal, shared risk for all participants.

Provably secure and unbreakable means:
The mathematics used is unsolvable other than brute force investigation of the entire possibility range and that takes essentially forever; and
The possible range of attack on each and every process step outcome is limited to a known range of results that are effectively handled by all the participants without monetary loss.

The mathematics claim has been verified by independent cryptographic experts and is currently under review by NIST for certification as a U.S. National Standard for Lightweight Cryptography; and the process security claims can easily be verified by any reader—which is the entire point of providing a transparent, understandable system (based on the verified mathematics).

Approach

The entirety of the “credit card” business and technical transaction model is based on using the actual, physical card as an authentication token. All of the complexity of all of the proposed credit transaction processing methods has been based on the faulty assumption that this is necessary. What is necessary is that the person asking to use credit for a purchase is indeed the person who has been granted credit by an entity from whom the merchant will be able to collect.

The requirement doesn't impose a physical card—that was just a method created when neither an instant communication system nor a positively secure encapsulating method of authentication credentials existed. The global, nearly universally available Internet has arrived to remove the first hurdle; and QwyitCash is now available to remove the second. When using QwyitCash over the Internet, the credit transaction is exactly the same as it's always been, only there isn't any need to carry a physical card.

There is a need, after having been granted credit under specific terms, for the borrower to carry some kind of authentication credentials that the credit issuer requires. Plainly, there is no need to ‘translate’ the credentials to a physical card with another unique data set (number, expiration, etc.)—there is only the need to digitize the credentials and securely store and present them whenever asking to borrow against one's credit line.

Further, there is the requirement for the merchant to be able to communicate with the issuer, and receive either approval or denial of the credit request, then act accordingly (sale or no sale), and collect on the debt (settlement). Whether or not a representative (or two) is inserted into the process of handling the package and the real money for the goods/services (merchant bank), isn't relative to the result—and their insertion should not add new requirements, only new data (identifying, accounts, etc.).

A credit transaction couldn't be any simpler—yet the current convoluted storage ideas (cards, devices that store cards, etc.) and horrifically complicated/complex communications transmissions keep getting worse and worse. QwyitCash has significantly streamlined the process and met all of the requirements of the necessary transaction parties, all while delivering provable security without a credit card.

System Requirements—Participants and Processes Definition

There are four participant classifications:
1. QwyitCash Issuer (QI)
2. QwyitCash Bank (QB)
3. Merchant
4. Consumer

There are four processes in the QwyitCash transaction system:
1. Participant Initial and Subsequent Registration
2. Normal Transaction Payment
3. Gift Transaction Creation
4. Gift Transaction Payment
   a. Gift Transaction Status—The Consumer can check whether they have available Gift Transactions (a small subset of GT Payment)
Merchants and QBs participant in 1, 2, and 4
Consumers and QIs participate in all
System Requirements—Message Format (All Processes)
All QwyitCash messaging uses a single standard message format that includes all of the necessary data elements for all of the transmissions in the system. This unique single format demonstrates the simplicity, transparency and security of the system. The element values and/or sender/receiver are listed in the process outlines.

The QC message format:
Field Name [Number of characters]—field information (value type, range if applicable)
Message Type [4]—QC process message type identifier (alphabet), generally XX-X; e.g., QM-S
OpenID [24]—Message Owner's ID (hexadecimal)
OpenID2 [24]—Target or partner Owner's ID; e.g., a Merchant's QB's ID (hexadecimal)
Authentication Token [256]—Owner's AuthToken/Keys at either a QI or QB (hexadecimal)
Result Flag (RF) [4]—Flag values for process step outcomes (alpha-numeric, A-F (capitals), 0-9)
Value Flag (VF) [24]—Flag values dependent on process step and RF values (all alpha-numeric)
Amount [18]—Dollar amount total (includes “.xx” as last 3 values, where xx are the cents (decimal), and the period is included. For refunds, there will be a “−” (minus sign) included.
TransactionID [48]—Current, or specific, transaction (hexadecimal) In total, comma delimited:
MT [4], OpenID [24], OpenID2 [24], AuthToken [256], RF [4], VF [24], Amount [18], TransactionID [48].

These field sizes will accommodate QwyitCash operation ‘forever’; as the AuthToken field size will hold a 1024-bit symmetric key/token (256-bit recommended currently). All other sizes accommodate a galaxy-worth of participants, transactions, dollars—all without any transmission or processing performance degradation. And this standard message is substantially smaller than current credit processing transmissions.

System Requirements—Messages

Description Format: Message Name, Sender/Owner, Receiver

### Registration Messages

QI-N: QwyitCash Issuer (QI) New Participant Registration→QC.com

QB-N: QwyitCash Bank (QB) New Participant Registration→QC.com

QI-O: QC.com reply with OpenID assignment→QI

QB-O: QC.com reply with OpenID assignment→QB

QI-K: QI New Participant Keys→QC.com

QB-K: QB New Participant Keys→QB.com

QI-C: QC.com Confirmation→QI

QB-C: QC.com Confirmation→QB

QM-N: Merchant New Participant Communication Check→QC.com

QC-N: Consumer New Participant Communication Check→QC.com

QM-R: QC.com reply→Merchant

QC-R: QC.com reply→Consumer

### Normal Transaction Processing Messages

QM-S: Merchant Start→QC.com

QM-R: QC.com Reply→Merchant

QCC: QwyitCash Code from QC.com→Merchant, Merchant→Consumer

QC-S: Consumer Start→QC.com

QC-R: QC.com Reply→Consumer

QI-S: QC.com QwyitCash Issuer Start→QI

QI-R: QI reply→QC.com

QM-R: QC.com reply→Merchant

QM-A: Merchant Accept→QC.com

QC-A: Consumer Accept→QC.com

QB-T: QC.com Settlement start→QwyitCash Bank (QB)

QI-T: QC.com Settlement start→QI

QB-R: QB reply→QC.com

QM-X: Merchant Cancel→QC.com

QC-X: Consumer Cancel→QC.com

### Gift Transaction Giving Processing Messages

QC-G: Consumer Gift Giving Transaction Start→QC.com

QI-G: QC.com QI Gift Start→QI

QI-R: QI reply→QC.com

QC-R: QC.com reply→Gift Giving Consumer

QC-A: Consumer Accept Gift Giving Transaction→QC.com

QI-T: QC.com QI Settlement Record→QI

### Gift Transaction Redemption Processing Messages

This process is an ‘overlay’ of Normal Transaction Processing, the only new messages:

QC-D: Consumer Decline Gifts→QC.com

QC-I: Consumer Interim Gift Transaction use→QC.com

QC-F: Consumer Last of Multiple Gift Transaction use→QC.com

System Requirements—Result Flag Values

The following are all of the Result Flag values for the QC processes:

### Registration Result Flags

ZNEW—New OpenID request or value reply

ZMQK—New Master Qwyit Key (MQK)

ZMEK—New Master Exchange Key (MEK)

ZNPC—New QwyitCash Participant (Merchant/Consumer) Confirmed—Registration Complete!

ZNWM—New Merchant Communication check

ZNWC—New Consumer Communication check and PIN storage

ZNMS—New Merchant Success—Registration Complete!

ZNCS—New Consumer Success—Registration Complete!

### Normal Transaction Processing Result Flags

ZZZZ—Not a viable Qwyit message. Try again.

ZZMS—Merchant Start message—open the transaction.

ZZCS—Consumer Start message—join the transaction by QCC found in VF

ZNRE—No Transaction Record Match! Check QC Code and Amount Entry and try again

ZCCC—QC.com has returned this transaction's QC Code—found in Value Flag (VF)

ZQIS—QI Start message—authorize the transaction.

ZATX—Issuer has received wrong Authentication Token—try again (although PIN is correct; key may be corrupt—possible re-registration), or choose another QwyitCash Issuer

ZCDX—Issuer has DENIED credit—choose another QwyitCash Issuer

ZFAA—Full Amount Approved! (Normal transaction)

ZZOK—Accepted transaction. Awaiting other party Acceptance and Settlement

XXXX—Transaction Canceled. End of Transaction.

ZDUN—Transaction Complete! Thank you!

ZPRB—Settlement Issue—to be corrected upon Audit

ZEND—Transaction Settlement Complete

### Gift Transaction Giving Processing Result Flags

ZCGT—Consumer Gift Giving Transaction (GGT)

ZQIG—QI Gift Transaction Start message—authorize the GGT

ZGOK—Consumer Accepted Gift Giving Transaction—GGT is now available for Recipient, QI notified of Consumer acceptance

ZGDN—Gift Giving Transaction Complete! Thank you!

### Gift Transaction Redemption Processing Result Flags

ZGTI—Gift Transaction available—One of multiple

ZGTF—Gift Transaction available—Last of multiple or Single

ZGTD—Consumer Declines to use any available Gift Transactions

ZQIR—QI Gift Transaction Redemption message—validate GGT, Recipient, Amount

ZGNR—No QI Gift Transaction record match! QC.com must cancel transaction with Consumer

ZGXX—No Gift Transaction confirmation, Transaction Canceled by QC.com. Try Again

ZFGA—Gift Transaction Approval (Gift Redemption)

### Gift Transaction Status Check Processing Result Flags

ZCGC—Consumer Gift Check

Note: If any participant receives a not-viable QwyitTalk communications message in any process, they will auto-reply to the sender to try again in a Qx-R format with an RF=ZZZZ. If receive two consecutive messages from the same entity, the reply will be with an RF=XXXX and any in-progress transaction will be canceled. The following message streams assume proper QwyitTalk formatted message traffic.

Registration Process

Registration Process Flow Diagram

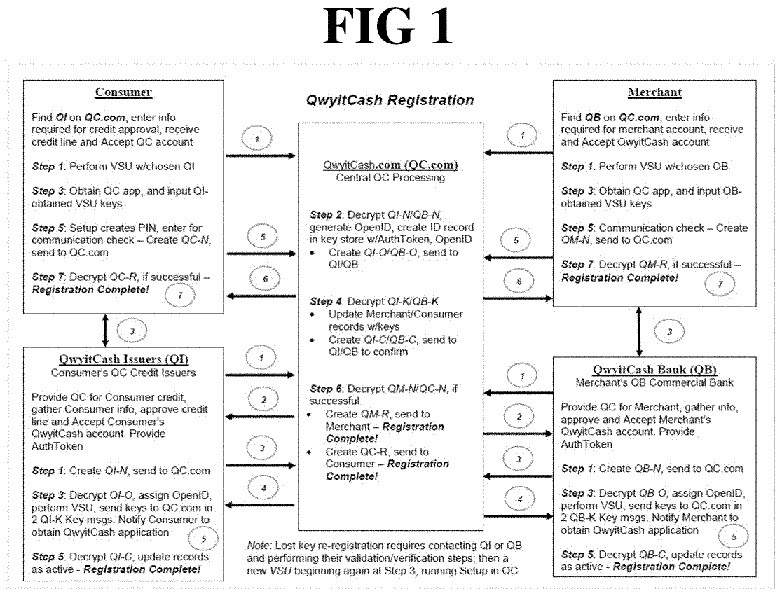

### See FIG. 1.

Registration Process—Overview

The following are the requirements to register for provision of QwyitCash credit transactions:
QIs and QBs will register at QwyitCash.com using Qwyit two-channel authentication; they will provide the required information for their QwyitCash participant classification using the Qwyit protocol Verified Setup (VSU).
   An entity may register as both classifications
   The QI and/or QB will operate the QwyitCash (QC) Provider software, which includes
      QI: Consumer registration, Transaction Processing, Approval and Settlement
      QB: Merchant registration, Transaction Processing, Approval and Settlement
Merchants and Consumers will register at their chosen QB or QI, respectively.
Consumers will register at any of the QwyitCash Issuers (QI) using the QI's process (online using HTTPS, paper form entry, etc.); they will provide QI requirements to purchase on credit
   Consumers can check the status and availability of any and all QIs at QwyitCash.com
   For first-time Consumer QwyitCash participation registration, QI provides all QwyitTalk communication registration (as detailed below using the QwyitTalk Verified Setup (VSU) process and submits to QC.com (OpenID, 2 QwyitTalk keys, Authentication Token)—QI doesn't keep the Consumer's QC.com communication keys
      QI provides a 256-bit 64-hex-digit Authentication Token to Consumer for submission whenever using this QI's line of credit for a purchase—this AuthToken is the credit card replacement
   For any subsequent Consumer QI registration(s), the Consumer must again meet the QI's process, beginning with a new 256-bit 64-hex-digit Authentication Token
   The QwyitCash app will store the QI as a choice to be selected during a QC transaction. The app will also store the Consumer's QwyitCash keys and AuthToken after encryption by their chosen PIN, as detailed below in the PIN Stealth section. During registration, the Consumer will also choose and enter a Personal Identifier (24 chars max). This will not need to be system-unique, as it will be in combination with their unique OpenID.
      Consumers will be publicly listed (OpenID and Personal Identifier) on QC.com once they have downloaded, opened and performed Setup with their QC app.
Merchants will register at any of the QwyitCash Banks (QB) using the QB's process (online, etc.); they will provide QB requirements for transaction settlement into their account(s)
   Merchants can check the status and availability of any and all QBs at QwyitCash.com
   For first-time Merchant QwyitCash participation registration, QB provides all QwyitTalk communication registration (also using QwyitTalk's VSU) and submits to QC.com (OpenID, 2 QwyitTalk keys, Token)—QB doesn't keep the Merchant's QC.com communication keys
      QB provides a 256-bit 64-hex-digit Authentication Token to Merchant for submission whenever using this QB's Bank for transaction settlement
   For any subsequent Merchant QB registration(s), the Merchant must again meet the QB's process, beginning with a new 256-bit 64-hex-digit Authentication Token
   The QwyitCash app will store the QB as the default settlement bank to be used during a QC transaction. The app will also store the Merchant's QwyitCash keys and AuthToken using any Best Practices storage technique, including PIN stealth (there isn't the same ‘lost device’ security requirement as there is for a Consumer's QwyitCash device.)
      Note: There are so many different types and sizes of Merchants; the number of QB registrations and/or tying together multiple locations, stores, online operations and servers, etc. may require an additional QwyitTalk network communications process for coordination. It also may easily be accomplished by individual POS registration. Regardless of the system in place, this document will treat/define a ‘Merchant’ as a single entity/single QwyitTalk keyed relationship. Any QwyitTalk network will be able to support this definition (accomplished by federated trust) while maintaining security.
As part of all participants registration noted above, they will perform a Qwyit VSU and receive their Qwyit communication keys (2, 64-hex-digits, 256-bits each recommended) as per the Qwyit Protocol Reference Guide
   QIs, QBs will properly store and protect these keys using Best Practices techniques
   Merchants will store and protect these keys dependent on their Qwyit network setup and POS communication processes, and as noted above
   Consumers will encrypt these keys in storage by memorizing the QwyitCash produced PIN shown during registration—this PIN is not stored anywhere other than in the Consumer's memory, and the keys are useless without PIN entry each transaction
   Consumer QwyitCash PIN is minimally a 6-hex-digit number, randomly generated
      Consumers may update this PIN at any time
      Consumers will have N tries to correctly enter the PIN before lock-out, being required to update registration (essentially, re-register) at their QI
      Lost or stolen QC-enabled smart phones will have a N in >16,777,216 chance of accessing QwyitCash and performing a successful transaction (this is considered secure)
      There are no static, off-line ‘dictionary’ attacks to know when the correct PIN is entered—only during a transaction will QC.com deny an incorrectly entered PIN (as the key decryption to generate the correct keys will be wrong)

### Registration Process—Details

Merchant/QB and Consumer/QI Step 1: Find desired QB (Merchant) or QI (Consumer) by reviewing those certified by QC.com as participating in QwyitCash credit processing and payment. After selection, follow the QC Provider's instructions in order to apply for an account; most likely, this will be performed online, using a secure HTTPS connection. After credit validation and verification, under the auspices of each individual QC Provider (this may be during the first session or some future interaction), at some point just after acceptance by both parties, the QC Provider will generate a unique Authentication Token for the Consumer/Merchant and request unique, unused OpenIDs from QC.com.

Note: Consumers certainly can register with multiple QwyitCash Issuers. All of the QC registration items will be held in a QC application running on their smart device; the application will handle multiple QI material. Merchants may register at different QwyitCash Banks, as well; except that QC Merchant transactions do not have a step for selecting a QB (for convenience!). If Merchants have multiple QBs, each POS QC app will need to have the default information for that POS session. Each POS may certainly have a different QB (and the QC POS app may allow storage of multiple QBs), but every transaction from a single POS during any one session will go to the same QB.

QI Step 1: Create QI-N:
Values: QI-N, QI, null, New Customer's AuthToken, ZNEW, null, 0.00, ABC123 (randomly assigned beginning here)
   For Consumers who are re-registering (for any reason), the QI may ask if they have registered previously. However the QI authenticates that they are the same person (address, etc.), must be the same way they authenticate originally. All of the QwyitCash registration info (OpenID, Keys, PIDs, PINs, etc.) will be replaced.
Send to QC.com
   Note: For all of the following, the descriptive word “Values:” is no longer repeated for the value assignments for each record.

QB Step 1: Create QB-N:
QB-N, QB, null, New Merchant's AuthToken, ZNEW, null, 0.00, ABC123 (randomly assigned beginning here)
   Re-registration will provide all new QC information
Send to QC.com

QC.com Step 2: Decrypt QI-NIQB-N
Generate unique OpenID; create a record in the key store for new Customer/Merchant, using new OpenID and their AuthToken. Create QI-OlQB-O:
   QB-O, QB, NewOpenID, New Merchant's AuthToken, ZNEW, null, 0.00, ABC123
   QI-O, QI, NewOpenID, New Customer's AuthToken, ZNEW, null, 0.00, ABC123
   Send to QI/QB

QI Step 3: Decrypt QI-O
Assign the new OpenID to their Consumer's account, matching their new Authentication Token
Perform a QwyitTalk VSU with the Consumer as per that protocol, in order to obtain their QwyitTalk keys used in QwyitCash
   Notify Consumer to go to QC.com, obtain proper platform QwyitCash application and perform first connect Setup—this will allow entry of the VSU keys and PID
   Part of the VSU registration with the QI will ask for input of a Personal Identifier (24 characters maximum). This should be something ‘unique’ and that can be given (and said) publicly (but there will be no check in any QI or QC.com records—the combination of this Personal ID (PID) with the coming truly unique OpenID will be singular—it's up to people to be decent.) This ID will be held publicly in the Consumer's QC app, as well as at QC.com—it is sent in this step
Upon completion of the VSU with the Consumer, send the keys and PID to QC.com for system participation—and delete the keys as they are not stored by the QI. Create QI-K:
   QI-K, QI, Consumer's OpenID, New Consumer's Master Qwyit Key (MQK), ZMQK, New Consumer's Personal ID, 0.00, ABC123
   Send to QC.com
   QI-K, QI, Consumer's OpenID, New Consumer's Master Exchange Key (MEK), ZMEK, New Consumer's Personal ID, 0.00, ABC123
   Send to QC.com

QB Step 3: Decrypt QB-O
Assign the new OpenID to their Merchant's account, matching their new AuthToken
Perform a QwyitTalk VSU with the Merchant as per that protocol, in order to obtain their QwyitTalk keys used in QwyitCash
   Notify Merchant to go to QC.com, obtain proper platform QwyitCash application and perform first connect Setup—this will allow entry of the VSU keys
Upon completion of the VSU with the Merchant, send the keys to QC.com for system participation—and delete the keys as they are not stored by the QB. Create QB-K:
   QB-K, QB, Merchant's OpenID, New Merchant's Master Qwyit Key (MQK), ZMQK, null, 0.00, ABC123
   Send to QC.com
   QB-K, QB, Merchant's OpenID, New Merchant's Master Exchange Key (MEK), ZMEK, null, 0.00, ABC123
   Send to QC.com

Merchant Step 3: Obtain QwyitCash application for their platform
Upon opening QC app, since there are no keys, it will prompt for OpenID and Key input (Setup menu item, for re-registrations)—performing the VSU at QB website has produced key value receipt in multiple channels; these will be entered into QwyitCash

Consumer Step 3: Obtain QwyitCash application for their platform
Upon opening QC app, since there are no keys, it will prompt for OpenID and Key input (Setup menu item, for re-registrations)—performing the VSU at QI website has produced key value receipt in multiple channels (and PID creation); these will be entered into QwyitCash

QC.com Step 4: Decrypt QI-KIQB-K
Update Consumer/Merchant records in the key store for new QwyitCash QwyitTalk keys, using new OpenID and their AuthToken.
Reply Confirmation of New QwyitCash Participant. Create QI-CIQB-C:
   QB-C, QB, NewOpenID, New Merchant's AuthToken, ZNPC, null, 0.00, ABC123
   QI-C, QI, NewOpenID, New Customer's AuthToken, ZNPC, null, 0.00, ABC123
   Send to QI/QB

QB Step 5: Decrypt QB-C
New QwyitCash Merchant participant Confirmed! Update records to show Active
REGISTRATION COMPLETE

QI Step 5: Decrypt QI-C
New QwyitCash Consumer participant Confirmed! Update records to show Active
REGISTRATION COMPLETE

Merchant Step 5: Continuing QC Setup
Merchant QwyitCash keys are stored in the application dependent on the platform and POS device form—portable, single-server network control, etc. The QC app will ask for appropriate input for key storage. Regardless of the type, there are no new data elements to be stored at QC.com (as there are with a Consumer), so the first message is simply a communication check. Create QM-N:
   QM-N, Merchant, OpenID, Merchant's AuthToken, ZNWM, null, 0.00, ABC123
   Send to QC.com

Consumer Step 5: Continuing QC Setup
Consumer QwyitCash keys are stored in the application using a PIN. The PIN is used by QwyitTalk to store a securely Qwyit-encrypted version; which must be decrypted by PIN entry every use. The PIN is an up-to-eight (8) hexadecimal digit value that is randomly assigned by the application—and prior to sending this confirmation, it will be generated and shown to the Consumer. Human memorization of up to 10 digits is routine (phone numbers, SSNs, etc.), and QwyitCash will use a minimum of six (6), with seven (7) preferable (presented as xxx-xxxx for quick memorization). The Consumer must memorize, and then enter the PIN to continue Setup—the PIN will never be stored anywhere, by any device.
   If unsuccessful (which will only be shown by the reply from QC.com in Step 7, Consumer will have two (n) additional attempts. N (N) unsuccessful entries will result in lockout, and the Consumer will need to return to Step 1, and re-register with their QI. (The number of unsuccessful tries will be tied to the PIN length)
Create QC-N:
   QC-N, Consumer, OpenID, Consumer's AuthToken, ZNWC, Personal Identifier, 0.00, ABC123
   Send to QC.com
Note: The Personal Identifier was entered along with the VSU key data—it is submitted to QC.com for use in positively identifying a participant (for Gift transactions, etc.).

QC.com Step 6: Decrypt QM-N
Upon successful decryption, reply Confirmation of New QwyitCash Participant.
Create QM-R:
   QM-R, QC.com, Merchant, Merchant's AuthToken, ZNMS, null, 0.00, ABC123
   Send to Merchant

QC.com Step 6: Decrypt QC-N
Upon successful decryption, add Personal Identifier to Consumer's record and reply Confirmation of New QwyitCash Participant. Create QC-R:
   QC-R, QC.com, Consumer, Consumer's AuthToken, ZNCS, null, 0.00, ABC123
   Send to Consumer

Note: It is possible, during this Consumer communication check, to allow/have the Consumer's QC-N include the PIN using the VF field. Then QC.com could update the Consumer's record in the key store to have the PIN. As there is no apparent, as yet, need for this (and it unnecessarily introduces the PIN into the message chain), it is not recommended.

Merchant Step 7: Decrypt QM-R
Upon successful decryption, If RF=ZNMS
   Screen says “Welcome to QwyitCash! You are Operational!”
   REGISTRATION COMPLETE

Consumer Step 7: Decrypt QC-R
Upon successful decryption, If RF=ZNCS
   Screen says “Welcome to QwyitCash! Better Than Money! You may charge at any participating merchant! Your PIN is AEF4 5678—you MUST memorize it to use QwyitCash. It is NOT stored! If you are unable to log in N times, you will be required to re-register at your QI!” The PIN will never be stored or shown again (as there is no storage of it); the Consumer must correctly enter it upon every QwyitCash transaction.
   REGISTRATION COMPLETE

Normal Transaction Payment

Normal Transaction Payment Flow Diagram

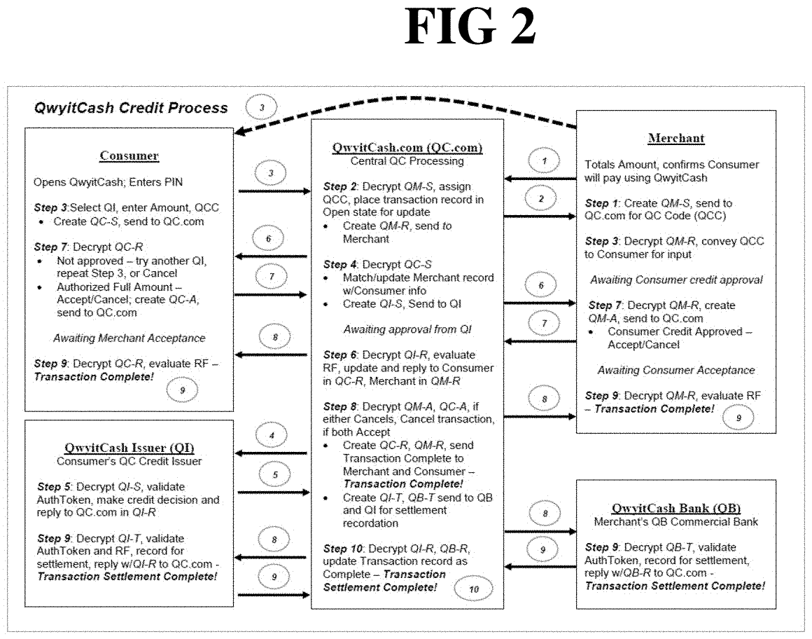

See FIG. 2.

Normal Transaction Payment—Overview

Normal Transaction Payment (QwyitCash Credit Processing) is identical to current Merchant—Consumer credit processing. QwyitCash has streamlined the process, fully securing it while removing the physical credit card—but hasn't changed the needs or preparedness of any of the participants. We invented a better way to perform and process credit transactions. The Merchant totals the merchandise or services to be bought, the Customer/Consumer is asked how they will pay, and QwyitCash (credit) is declared. The Consumer asks their lender to back the purchase, the Merchant's bank and the Consumer's credit Issuer transact a financial exchange, and the Consumer takes the good/services. QwyitCash transaction processing works for all types of credit transactions, including Internet, physical location, phone, restaurant, etc.

Normal Transaction Payment—Unique QwyitCash Codes (OCC)

These 23-unique alpha-numeric values (called QC codes, QCC), creating 12,167 (23³) possible Codes for each transaction amount, will be either shown, told or automated from the Merchant to the Consumer in Step 3, joining the transaction. These values have unique spoken and written characteristics in order to avoid verbal communication and input errors; for translating QwyitCash to other languages, these codes may be adjusted to retain spoken/written uniqueness. Merchant screens may/should be designed for easy Consumer reference to distinctly show the three code values along with the transaction Amount (where not read automatically by the Consumer's smart device):

a b, f, h, i, m, o, q, r, s, u, w, x, y, 1, 2, 4, 5, 6, 7, 8, 9, 0

Notes on Transaction Synching

Consumer Step 3 entails entering the 3-character QCC. While noted that this entry may be automated, and code definition has been limited for verbal communication error reduction, there is a small possibility of waiting for a clear code. There are 12,167 QCC's per transaction amount available during any open transaction interval (lasting from 5-120 seconds, estimated approximately.) It is possible that all codes are being used, and any particular transaction will need to wait until a transaction is closed (canceled or completed) and a code becomes available. This will almost never occur, even if every credit transaction in the world were to be QwyitCash processed. [e.g., ˜400 B/year =190K/15-seconds, with an average of 10K different values ($50-150 average transaction), each w/12,167 codes leaves 121.7M codes to cover 190K transactions.] Should it occur, the transaction would simply be delayed by a few seconds as codes ‘roll off’ in order to send an available Code for the Merchant to provide. If desired, the QCC can be increased to 4 characters, with each Amount having 279,841 values; the only drawback is more Consumer error possibilities (unless QCC and Amount entry are automated, in which case 4 characters would be recommended.)

Should the Consumer enter the wrong code, their reply will alert them to ‘No Transaction Record match’, Result Flag=ZNRE, and they would re-enter the correct value. With manual entry, there is a minute chance of entering the wrong code that happens to be the correct code for another open Consumer transaction for the exact amount. This error is eliminated with automated entry—if it passed, and ‘no one noticed’ (all parties), the finances are correct, but the payees are wrong; yes this might have tax or other implications (Merchant sales taxes, etc.), but an error to completion is nearly impossible.

Normal Transaction Payment Credit Processing—Details

Note: All QwyitCash platform software applications for Merchant and Consumer will always show a Cancel button so any transaction may be terminated by either party at any time up until Merchant and Consumer both Accept the transaction.

Merchant Step 1: Create QM-S message after totaling Amount and confirming that Consumer will pay using QwyitCash
QM-S, Merchant, Merchant's QB, Merchant AuthToken for this QB, ZZMS, null, xxx.xx, ABC123 (randomly assigned beginning here)
   Amount may include “−” for a refund
Send to QC.com

Note: Some Merchants may allow Consumer to pay partial amounts using QwyitCash, and the rest of the transaction in other ways. If this is to be done, the Merchant MUST only start a QC transaction for the PARTIAL amount. This is because of the transaction joining method; so Merchant must split the purchase PRIOR to starting a QC credit transaction.

QC.com Step 2: Decrypt QM-S, Evaluate RF
Open Normal Status transaction record w/QM-S values
Assign unique QCC (await open QC Code value per amount, if necessary), add to record
Create QM-R, reply to Merchant
   Values: QM-R, QC.com, Merchant's QB, Merchant, ZCCC, abf, xxx.xx, ABC123 (where VF=assigned QCC)
   Send to Merchant

Merchant Step 3: Decrypt QM-R, evaluate RF and VF
Convey QCC to Consumer

Note: It is certainly possible to allow the Consumer's smart device to ‘read’ the QCC from the Merchant, automating entry and reducing errors. This is opposite of current systems where Merchant devices read Consumer devices. Existing hardware (photo and image processing) already exists on most smart devices, so this automation wouldn't involve any cost.

Consumer Step 3: Opens QwyitCash application, enters PIN, selects QI for this transaction, enters Amount, and QCC; this creates QC-S message

QC-S, Consumer, QI's ID, Consumer's QI AuthToken, ZZCS, abf, xxx.xx, null (where VF=input QCC, which must match Merchant QCC and Amount)
The TransactionID will be null in this first QC-S until synched with the Merchants
   Send to QC.com

### QC.com Step 4: Decrypt QC-S

If RF=ZZCS: Find QCC/Amount match in open QM-S records awaiting payment settlement
No such record exists
   Create QC-R, RF=ZNRE
      QC-R, QC.com, Consumer, null, ZNRE, null, xxx.xx, ABC123
      Send to Consumer to try again (QC software will show ‘Wrong amount or Code—try again’, and Consumer would repeat Step 3 from the beginning (PIN, etc.))
QM-S Record found
   Update with Consumer info (Consumer's OpenID, QI-AuthToken, QI-OpenID, QCC and Amount (record has now been synched)
   Next—check if there are any OPEN Gift transactions available for this Consumer. If NO, proceed
      Create QI-S (QI Authorization record)
         QI-S, QC.com, QI's OpenID, Consumer's AuthToken, ZQIS, null, xxx.xx, ABC123
         Send to QI
   If YES, proceed for Gift-based transaction—See Gift Redemption for complete process details

### QI Step 5: Decrypt QI-S

Validate Consumer's AuthToken, and if OK, make credit decision based on person and Amount and record all QwyitCash record values for billing consumer, etc. This record must be accepted by the Consumer in Step 7 and isn't final until receiving a QI-T request.
Wrong Authentication Token
   Create QI-R, set RF=ZATX, Amount=0.00
      QI-R, QI, Consumer, null, ZATX, null, 0.00, ABC123
      Send to QC.com
Credit Denied
   Create QI-R, RF=ZCDX, Amount=0.00
      QI-R, QI, Consumer, null, ZCDX, null, 0.00, ABC123
      Send to QC.com
Credit Approved—Full Amount requested
   Create QI-R, RF=ZFAA, Amount=full amount allowed, xxx.xx
      QI-R, QI, Consumer, null, ZFAA, null, xxx.xx, ABC123
      Send to QC.com
         QC.com Step 6: Decrypt QI-R (Replies, as all of the messaging, are matched by TransactionID)

For the following RF values, Reply to Consumer because of issues

If RF=ZATX
Create QC-R, RF=ZATX, Amount=0.00
   QC-R, QC.com, QI, Consumer's AuthToken, ZATX, null, 0.00, ABC123
   Send to Consumer

If RF=ZCDX
Create QC-R, RF=ZCDX, Amount=0.00
   QC-R, QC.com, QI, null, ZCDX, null, 0.00, ABC123
   Send to Consumer

For the following RF value, Reply to Consumer and Merchant—credit approved

If RF=ZFAA Then Full Amount Approved
Update transaction w/QI approval (Approved amount will equal Transaction amount, so proceed)
Create QC-R, RF=ZFAA, Amount=QI approved Amount
   QC-R, QC.com, QI, null, ZFAA, null, xxx.xx, ABC123
   Send to Consumer
Create QM-R, RF=ZFAA, Amount=QI approved Amount
   QM-R, QC.com, Consumer, null, ZFAA, Personal ID, xxx.xx, ABC123
   Send to Merchant
      Merchant Step 7: Decrypt QM-R, evaluate RF (If Merchant is keeping an audit log of all transactions, the Consumer's OpenID and PID is returned in this credit reply for synching to transaction)

If RF =ZFAA then Screen notified “Consumer Credit Approved! Accept/Cancel?” Show the QCC and Amount
Create QM-A, RF=ZZOK (Accept), RF=XXXX (Cancel)
QM-A, Merchant, QB's ID, Merchant's QB AuthToken, ZZOK, abf, xxx.xx, ABC123
Send to QC.com
   Consumer Step 7: Decrypt QC-R (Consumer now has the proper TransactionID)

If RF=ZATX then Screen notified “Authentication Code error—Try again or choose another QwyitCash Issuer”
Begin again at Step 3 (using same QCC)
If occurs a 2^{nd} time, ABORT TRANSACTION by performing Step X—and check for connection/key storage errors

If RF=ZCDX then Screen notified “Credit has been DENIED—Cancel or Try again with a different QwyitCash Issuer”
Begin again at Step 3 (using same QCC, but different QI)

If RF=ZFAA then Screen notified “Approved! Accept/Cancel?” Show the QCC and Amount
Create QC-A, RF=ZZOK (Accept), RF=XXXX (Cancel)
QC-A, Consumer, QI's ID, Consumer's QI AuthToken, ZZOK, abf, xxx.xx, ABC123
Send to QC.com

If RF=ZNRE then Screen notified “Wrong Amount or Code—Try entering again”
Begin again at Step 3 (using same QCC)
If occurs a 2^{nd} time, ABORT TRANSACTION by performing Step X—and check for connection/key storage errors

### QC.com Step 8: Decrypt QM-A, QC-A

For either RF=XXXX (Merchant and/or Consumer Canceled)
Follow Step X process for Transaction Cancelation

For both RF=ZZOK (both have Accepted)
Update QM-S Open Normal Transaction record for both acceptance
Create QM-R, reply to Merchant
   QM-R, QC.com, Merchant's QB, null, ZDUN, abf, xxx.xx, ABC123
   Send to Merchant
Create QC-R, reply to Consumer
   QC-R, QC.com, Consumer's QI, null, ZDUN, abf, xxx.xx, ABC123
   Send to Consumer
Create QB-T (QB Settlement record)
   QB-T, QC.com, QI's OpenID, Merchant's AuthToken, ZDUN, abf, xxx.xx, ABC123
   Send to QB
Create QI-T (QI Settlement record)
   QI-T, QC.com, QB's OpenID, Consumer's AuthToken, ZDUN, abf, xxx.xx, ABC123
   Send to QI
   No need here to wait for QB/QI reply—if unsuccessful for any reason, QM-S record will remain OPEN for periodic (24 hour recommended) audit and final settlement

### QI Step 9: Decrypt QI-T

Validate Consumer's AuthToken, and if OK (can also check against the previously approved credit decision) and record all QwyitCash values for settlement, etc.—Settlement will be with the same TransactionID at the QB's OpenID in OpenID2
Wrong Authentication Token
   Create QI-R, RF=ZPRB, Amount=xxx.xx
      QI-R, QI, QB, Consumer's AuthToken, ZPRB, null, xxx.xx, ABC123
      Send to QC.com
Settlement Approved
   Create QI-R, RF=ZEND, Amount=xxx.xx
      QI-R, QI, QB, Consumer's AuthToken, ZEND, null, xxx.xx, ABC123
      Send to QC.com

### QB Step 9: Decrypt QB-T

Validate Merchant's AuthToken, and if OK record all QwyitCash values for settlement, etc.—Settlement will be with the same TransactionID at the QI's OpenID in OpenID2
Wrong Authentication Token
   Create QB-R, RF=ZPRB, Amount=xxx.xx
      QB-R, QB, QI, Merchant's AuthToken, ZPRB, null, xxx.xx, ABC123
      Send to QC.com
Settlement Approved
   Create QB-R, RF=ZEND, Amount=xxx.xx
      QB-R, QB, QI, Merchant's AuthToken, ZEND, null, xxx.xx, ABC123
      Send to QC.com

### Merchant Step 9: Decrypt QM-R

Evaluate RF
If RF=ZDUN then Screen notified “Transaction Complete! Thank Your Customer!”
   TRANSACTION COMPLETE

### Consumer Step 9: Decrypt QC-R

Evaluate RF
If RF=ZDUN then Screen notified “Transaction Complete! Enjoy your merchandise!”
   TRANSACTION COMPLETE

### QC.com Step 10: Decrypt QB-R, QI-R

If RF=ZEND
Update QM-S record as having successfully notified QB and/or QI for settlement

If RF=ZPRB
Update QM-S record as having a QB and/or QI settlement error (of any type)

TRANSACTION COMPLETE

QC.com Step Periodic (some minute interval): Check QM-S records for completeness—will have both QI and QB settlement codes (the corresponding RF values):

If both values=ZEND, then move the QM-S record to the Complete Settlement area for audit storage

If either value=ZPRB, then move the QM-S record to the Settlement Problem Area for periodic submission for resolution to the corresponding QI and QB (24-hour recommended, in a TBD QwyitTalk communication sequence, if desired)

Merchant Step X: Merchant can cancel any time prior to Acceptance in Step 7

Create QM-X message, RF=XXXX
QM-X, Merchant, null, null, XXXX, QCC, xxx.xx, ABC123
Send to QC.com
   Consumer Step X: Consumer can cancel any time prior to Acceptance in Step 7

Create QC-X message, RF=XXXX
QC-X, Consumer, null, null, XXXX, QCC, xxx.xx, ABC123
Send to QC.com
   QC.com Step X: If at any time, receive a QM-X or QC-X message:

Decrypt QM-X or QC-X, evaluate RF, if RF=XXXX
Look for, and if exists, update QM-S Open Normal Transaction from Open status to Canceled
   If record does not exist, simply ignore

### Gift Transaction Creation

### Gift Transaction Creation Flow Diagram

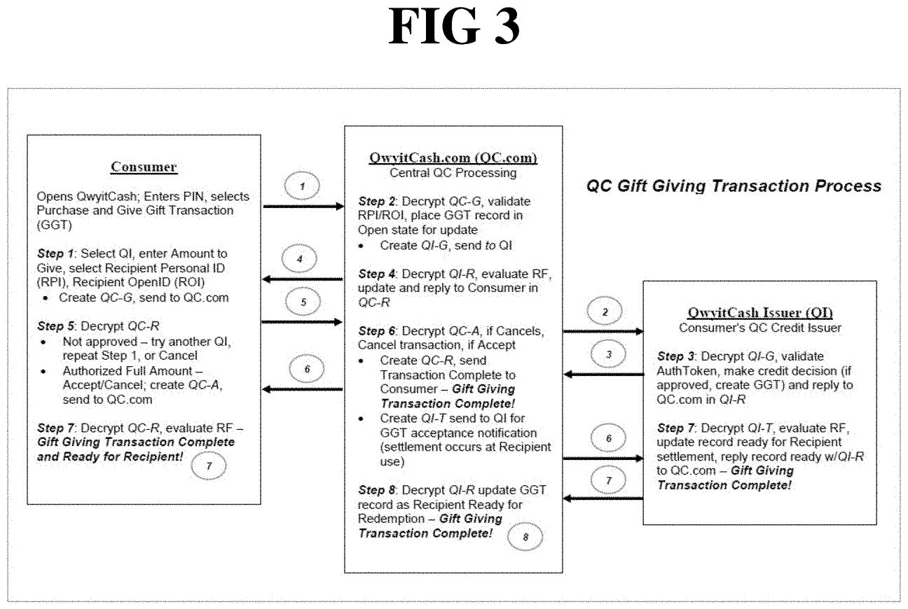

### See FIG. 3.

Gift Transaction Creation—Overview

The streamlined QwyitCash system enables Consumers to ‘buy gift cards’ for each other—and just as with the removal of the physical credit card from normal credit transactions, QwyitCash has removed the physical gift card from Gift Card purchases. This does not impact the purchase of any particular Merchant's cards, but it does remove the need to buy Credit Card Processor and Bank/debit cards (such as a Visa™ gift card.) Gift Transaction Creation allows any Consumer to give another QwyitCash participating Consumer a Gift Transaction that they may use everywhere QwyitCash is accepted. Whenever paying by QC, the Consumer will be notified that they have Gift Transactions available (shown the Amounts and from which Consumers) and asked if they want to use one (or more). This is akin to PayPal® Personal without the cash transaction fees—and just like buying a Credit Gift Card, but without the physical card.

Gift Transaction Creation—Purchase and Give Gift Transaction Processing—Details

Consumer Step 1: Opens QwyitCash application, enters PIN, and selects Purchase and Give Gift Transaction (GT). Selects QI for this Gift Giving Transaction (GGT), enters Amount to Give, and the Personal Identifier of the recipient (RPI), and the OpenID of the recipient (ROI); this creates a QC-G message
QC-G, Consumer's OID, ROI, Consumer's Chosen-QI AuthToken, ZCGT, RPI, xxx.xx (Amount to Give), TransactionID (Created here to start, ABC123)
Send to QC.com

Note: QC.com will have all QC Consumer participants listed publicly by Personal ID and OpenID. QC app will HTTP (publicly) connect to QC.com and allow Consumers to select recipients and auto-fill the values. This should be a requirement to avoid multiple cyclic transmissions with failed recipient value entry attempts. There will also be a warning: “Are you sure this is the correct recipient? If not, a stranger will be given your gift!” There will NOT be any way for a Giver to cancel an approved GGT; double acceptance of the entered recipient should be standard app practice for Step 1. (Consumer will again accept this recipient, for the 3^{rd} time, in Step 5.)

QC.com Step 2: Decrypt QC-G and Identify recipient (by ROI/RPI)
No record exists for Recipient
   Reply to Consumer to try again at Step 1 (may happen more than once)
Record exists for Recipient, create Open Gift Giving Transaction (GGT) record w/Consumer and Recipient values, including storing the QI's info (for future settlement)
   Create QI-G (QI Gift Authorization record)
      QI-G, QC.com, QI's OpenID, Consumer's AuthToken, ZQIG, RPI, xxx.xx, ABC123
      Send to QI

QI Step 3: Decrypt QI-G
Validate Consumer's AuthToken, and if OK, make credit decision based on person and Amount and record all QwyitCash record values for billing consumer, etc. This record is different than a Normal Transaction in that it may be held for an extended period of time prior to settlement; the originating (Gift Giving) Consumer will be billed, but the record will be settled during another transactions QI-S record. QI's will handle these as required. These records must be accepted by the Consumer in Step 5.
   Wrong Authentication Token
      Create QI-R, set RF=ZATX, Amount=0.00
         QI-R, QI, Consumer, Consumer's AuthToken, ZATX, null, 0.00, ABC123
         Send to QC.com
Credit Denied
   Create QI-R, RF=ZCDX, Amount=0.00
      QI-R, QI, Consumer, null, ZCDX, null, 0.00, ABC123
      Send to QC.com
Credit Approved—Full Amount requested
   Create QI-R, RF=ZFAA, Amount=full amount allowed, xxx.xx
      QI-R, QI, Consumer, null, ZFAA, null, xxx.xx, ABC123
      Send to QC.com

QC.com Step 4: Decrypt QI-R (These QI replies are matched by TransactionID—they are the same credit codes for both Normal and Gift Giving Transactions)

For the following RF values, Reply to Consumer because of issues
If RF=ZATX
   Create QC-R, RF=ZATX, Amount=0.00
      QC-R, QC.com, QI, Consumer's AuthToken, ZATX, null, 0.00, ABC123
      Send to Consumer
If RF=ZCDX
   Create QC-R, RF=ZCDX, Amount=0.00
      QC-R, QC.com, QI, null, ZCDX, null, 0.00, ABC123
      Send to Consumer

For the following RF value, Reply to Consumer—credit approved
If RF=ZFAA Then Full Amount Approved
   Match by TransactionID in GGT, update transaction w/QI approval
   Create QC-R, RF=ZFAA, Amount=QI approved Amount
      QC-R, QC.com, QI, null, ZFAA, null, xxx.xx, ABC123
      Send to Consumer

Consumer Step 5: Decrypt QC-R
Evaluate RF and Amount
   If RF=ZATX then Screen notified “Authentication Code error—Try again or choose another QwyitCash Issuer”
      Begin again at Step 1 (re-try, choose another QI, or cancel)
      If occurs a 2^{nd} time with same QI, ABORT TRANSACTION by performing Step X—and check for connection/key storage errors (re-register w/QI as AuthToken may be corrupt)
   If RF=ZCDX then Screen notified “Credit has been DENIED—Cancel or Try again with a different QwyitCash Issuer”
      Begin again at Step 1 (choose a different QI, or cancel)
   If RF=ZFAA then Screen notified “Approved! Accept to Give Gift or Cancel?” Show the RPI/ROI and Amount
      Create QC-A, RF=ZGOK (Accept), RF=XXXX (Cancel)
      QC-A, Consumer, ROI, null, ZGOK, RPI, xxx.xx, ABC123
      Send to QC.com

QC.com Step 6: Decrypt QC-A
For RF=XXXX (Consumer Canceled)
   Follow Step X process for Transaction Cancelation—GIFT GIVING TRANSACTION CANCELED
For RF=ZGOK (Consumer Accepted)
   Update Open GGT record for acceptance and sent to QI for final readiness
   Create QC-R, reply to Consumer
      QC-R, QC.com, ROI, null, ZGDN, Personal ID, xxx.xx, ABC123
      Send to Consumer
   Create QI-T (QI Settlement record)
      QI-T, QC.com, ROI, Consumer's AuthToken, ZGOK, Personal ID, xxx.xx, ABC123
      Send to QI

Consumer Step 7: Decrypt QC-R
Evaluate RF
   If RF=ZGDN then Screen notified “Gift Giving Transaction Complete! Gift Transaction is available for Recipient!”
      GIFT GIVING TRANSACTION COMPLETE

QI Step 7: Decrypt QI-T
Evaluate RF and TransactionID
   If RF=ZGOK then Update GGT, bill Giving Consumer and ready record for subsequent, final settlement when used by Recipient
      Create QI-R, RF=ZGDN, Amount=xxx.xx
         QI-R, QI, Giving Consumer, null, ZGDN, null, xxx.xx, ABC123
         Send to QC.com
      GIFT GIVING TRANSACTION COMPLETE

Note: QI is alerted that their Open GGT (however they have recorded it in their DB) is now accepted and active for the Recipient (ROI/RPI now known, recorded in QI's GGT). This is important because they will receive a QI-S message from QC.com to use this record/transaction for credit approval against some other QM-S sale, which will have a different TransactionID. Final settlement doesn't happen now, but later when the Recipient uses the GGT-QI holds the funds after billing Giving Consumer.

QC.com Step 8: Decrypt QI-R
For RF=ZGDN (QI Recipient Ready)
   Update Open GGT to QI availability to Recipient, GGT Complete!
GIFT GIVING TRANSACTION COMPLETE

Consumer Step X: Consumer can cancel any time prior to Acceptance in Step 5
Create QC-X message, RF=XXXX
   QC-X, Consumer, null, null, XXXX, Recipient's Personal ID, xxx.xx, ABC123
   Send to QC.com

QC.com Step X: If at any time, receive a QC-X message:
Decrypt QC-X, evaluate RF, if RF=XXXX
   Look for, and if exists, update QC-G Open Gift Giving Transaction from Open status to Canceled
      If record does not exist, simply ignore

Gift Transaction Payment

Gift Transaction Payment (Redemption) Flow Diagram

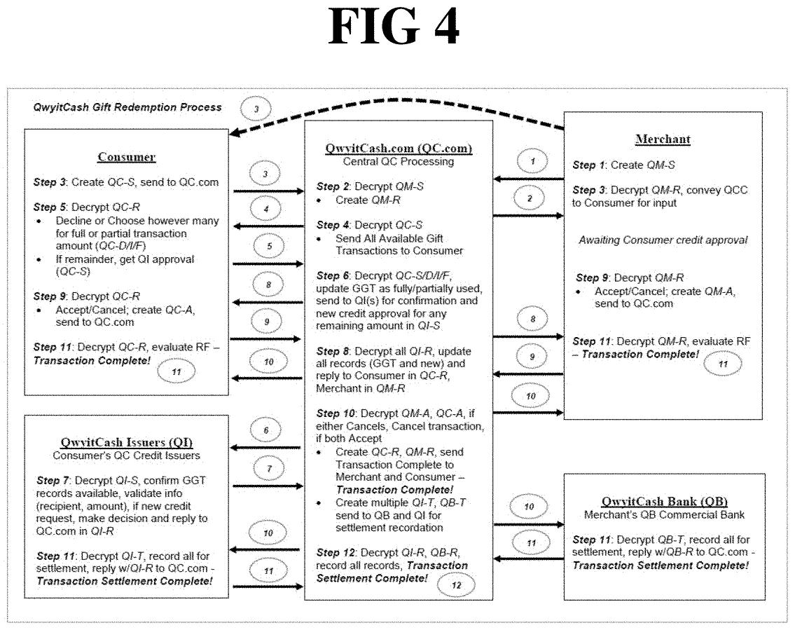

See FIG. 4.

Gift Transaction Payment (Redemption) Processing—Overview

For any QwyitCash payment transaction, after synching with the Merchant's sales transaction, the Consumer will be notified if they have any available Gift Transactions; these are called Gift Giving Transactions (GGT) in the system, and are marked by the sending Consumer, the receiving Consumer (recipient) and the amount available. The Consumer may choose none, one, or many to cover the transaction amount. Should the Consumer choose not to use any GGTs, then the transaction is processed normally. If the Consumer chooses a GGT that is equal to or greater than the transaction, just that payment will be used (and if greater, the amount remaining is adjusted). If there is a remaining amount on the transaction after GGT selection (which can be more than one), then the Consumer's QI entry during the synch step will be used for credit approval.

Gift Transaction Payment (Redemption) Processing—Details

Note: Where the step, or parts of it, is identical to Normal Transaction Processing, the details are omitted since they can be found above.

Merchant Step 1: Create QM-S

QC.com Step 2: Decrypt QM-S

Merchant Step 3: Decrypt QM-R, Convey QCC to Consumer

Consumer Step 3: Opens QwyitCash application, enters PIN, selects QI for this transaction, enters Amount, and QCC; this creates QC-S message
For simply checking the status of any available Gift Transactions, set RF=ZCGC and there would be no QI/Amount/QCC (See Gift Transaction Status Check); otherwise this QC-S is identical to Normal Processing
Send to QC.com

QC.com Step 4: Decrypt QC-S
If RF=ZZCS: Find QCC/Amount match in open QM-S records awaiting payment settlement
   No such record exists
   QM-S Record found
      First—check if there are any OPEN Gift transactions available for this Consumer. If NO, proceed as per Normal Transaction Processing
      If YES, proceed here for Gift-based transaction—after updating the Merchant Transaction created in Step 2 to Gift Status (indicating this (where updated) unique, processing).
      This access point is also performed upon receiving a Step 3 QC-S request where RF=ZCGC (Consumer Gift Transaction Check)—see Gift Transaction Status Check
         All of the available Gift Transactions will now be sent to Consumer (one per transmission); RF=ZGTI for each available where multiple, RF=ZGTF for single or final of multiple available
      Create QC-R, RF=ZGTI (if multiple, for each except last)
         QC-R, QC.com, OpenID of Giver, null, ZGTI, Personal ID of Giver, xxx.xx (amount of gift available), ABC123
         Send to Consumer to ask if want to use (QC software will ready each of these for display to Consumer)
      Create QC-R, RF=ZGTF
         QC-R, QC.com, OpenID of Giver, null, ZGTF, Personal ID of Giver, xxx.xx (amount of gift available), ABC123
         Send to Consumer to ask if want to use (QC software will ready this for display to Consumer)
            Consumer Step 5: Decrypt QC-R (Consumer now has proper TransactionID)

Evaluate RF and Amount. If RF=ZGTI or ZGTF then Screen notified “You have Gift Transactions—want to use it?” (or “one or more?” if multiple). Reminder: at this point, QC.com has already synched and updated the QM-S record w/Consumer's info, including QI info should the GTs not add up to the total transaction value. Once Consumer has selected enough GTs to equal or exceed the transaction amount, app will interrupt and ask to send.
Consumer chooses NOT to use any GT
   Create QC-D, RF=ZGTD (Decline), QC app has already synched and updated the QM-S record
   QC-D, Consumer, null, null, ZGTD, null, null, ABC123
   Send to QC.com
If Consumer chooses to use MORE THAN ONE GT (there can be more than one of the interim; e.g. Consumer has 5 GTs available, and choses to use 3, there will be two (2) ZGTI replies and one (1) ZGTF reply)
   Create QC-I, RF=ZGTI
   QC-A, Consumer, OpenID of Chosen Giver, null, ZGTI, Personal ID of Chosen Giver, xxx.xx (Amount of Gift), ABC123
   Send to QC.com
Consumer chooses to use a SINGLE GT or LAST of multiple GTs
   Create QC-F, RF=ZGTF
   QC-A, Consumer, OpenID of Chosen Giver, null, ZGTF, Personal ID of Chosen Giver, xxx.xx (Amount of Gift), ABC123
   Send to QC.com
      QC.com Step 6: Decrypt QC-D, QC-I, QC-F, reply from Consumer to use/decline GT(s)

If RF=ZGTD: Consumer has declined use of any GT(s)
END OF GIFT REDEMPTION—Continue in Normal processing at Step 4, send to QI with info Consumer provided in Step 3, original QC-S

If RF=ZGTI: Consumer has accepted multiple GTs, more transmissions coming
Decrypt QC-I
   Check Merchant Total Amount—Gift Amount=Running Merchant Total Amount; QC app dictates the running total must still be>0 and the total Gift Amount is to be used (otherwise, not a QC-I)
   Update GT record as TOTAL USED
      Create QI-S
         QI-S, OpenID of Recipient (Consumer), OpenID of Gift Giver, null, ZQIR, Personal ID of Recipient (Consumer), xxx.xx (Amount of Gift), ABC123
         Send to QI

If RF=ZGTF: Last (only) Consumer accepted GT, end of Gift transmissions
Decrypt QC-F, Get Gift Amount, have Running Merchant Total Amount (If there have been no QC-I messages, this is just the Merchant Total Amount)
   Check Running Merchant Total Amount−Gift Amount=Remaining Total
   If Remaining Total=0
      Update GT record as TOTAL USED
         Create QI-S
         QI-S, OpenID of Recipient (Consumer), OpenID of Gift Giver, null, ZQIR, Personal ID of Recipient (Consumer), xxx.xx (Gift Amount), ABC123
         Send to QI
   If Remaining Total is <0 then subtract Running Total from Gift Amount for Gift Amount to be Used, and Gift Amount—Gift Amount to be Used=Remaining Gift Amount
      Update GT record as PARTIAL USED, update to Remaining Gift Amount, send Gift Amount to be Used to QI
         Create QI-S
         QI-S, OpenID of Recipient (Consumer), OpenID of Gift Giver, null, ZQIR, Personal ID of Recipient (Consumer), xxx.xx (Gift Amount to be Used), ABC123
         Send to QI
   If Remaining Total >0, so full Gift Amount is to be sent, and the Remaining Total of the transaction will need to be sent to the Original QI for approval
      Update GT record as TOTAL USED
         Create QI-S
         QI-S, OpenID of Recipient (Consumer), OpenID of Gift Giver, null, ZQIR, Personal ID of Recipient (Consumer), xxx.xx (Gift Amount), ABC123
         Send to QI
         Create QI-S
         QI-S, QC.com, QI's OpenID, Consumer's AuthToken, ZQIS, null, xxx.xx (Remaining Total), ABC123
         Send to QI

Note: There could be several different QI's sent to in this Step; the addresses are found in the GGT records from matching the Recipient, Giver OpenIDs and Amounts. The OpenID (e.g., address) of which QIs to send to will have been stored in the original GGT records during Step 2 of Gift Giving Transaction Processing.

QI Step 7: Decrypt QI-S, evaluate RF; If=ZQIR, these are Gift Redemptions

Validate GGT by Recipient OpenID (ROI), Recipient Personal ID (RPI), Amount, Gift Giver's Open ID and whether still available (TransactionID will be different, as record created in Giving transaction process, and transaction is already authorized and billed to Giving Consumer). Compare amounts; if amount requested is same (cannot be more), mark record as TOTAL USED AWAITING CONSUMER ACCEPT. If amount requested is less, mark record as PARTIAL USED AWAITING CONSUMER ACCEPT, noting amount.
No such record (somehow, QC.com had an open available GGT that QI does not—this shouldn't happen, but, if does . . . )
   Create QI-R, set RF=ZGNR, Amount=0.00
      QI-R, OpenID of Recipient, OpenID of Gift Giver, null, ZGNR, Personal ID of Recipient, 0.00, ABC123
      Send to QC.com
GGT Available and Approved—Full Amount requested
   Create QI-R, RF=ZFGA, Amount=full amount allowed, xxx.xx
      QI-R, QI, Consumer, null, ZFAA, null, xxx.xx, ABC123
      Send to QC.com
         Decrypt QI-S, If=ZQIS, this MAY occur—it is for any Remaining Total after Gifts used

Validate Consumer's AuthToken, and if OK, make credit decision based on person and Amount and record all QwyitCash record values for billing consumer, etc. This record must be accepted by the Consumer in Step 8 and isn't final until receiving a QI-T request.
Wrong Authentication Token
   Create QI-R, set RF=ZATX, Amount=0.00
      QI-R, QI, Consumer, Consumer's AuthToken, ZATX, null, 0.00, ABC123
      Send to QC.com
Credit Denied
   Create QI-R, RF=ZCDX, Amount=0.00
      QI-R, QI, Consumer, null, ZCDX, null, 0.00, ABC123
      Send to QC.com
Credit Approved—Remaining Amount requested
   Create QI-R, RF=ZFAA, Amount=Remaining amount allowed, xxx.xx
      QI-R, QI, Consumer, null, ZFAA, null, xxx.xx, ABC123
      Send to QC.com

Note: This step may be performed by multiple QI's, as the Consumer may have multiple GGTs provided by different Giving Consumers using different QI's; as well as a remaining transaction amount needing approval.

### QC.com Step 8: Decrypt QI-R

For the following RF values, Reply to Consumer because of issues

If RF=ZGNR (QI did not have an open Gift Transaction for that Recipient, given by that Gift Giver)—mark Open GGT as ERROR, CLOSED AT QI.
Create QC-R, RF=ZGXX, Amount=0.00
   QC-X, QC.com, QI's OpenID, null, ZGXX, Personal ID of Gift Giver, 0.00, ABC123
   Send to Consumer

If RF=ZATX
Create QC-R, RF=ZATX, Amount=0.00
   QC-R, QC.com, QI, Consumer's AuthToken, ZATX, null, 0.00, ABC123
   Send to Consumer

If RF=ZCDX
Create QC-R, RF=ZCDX, Amount=0.00
   QC-R, QC.com, QI, null, ZCDX, null, 0.00, ABC123
   Send to Consumer
      For the following RF value, Reply to Consumer and Merchant—credit approved;

If RF=ZFAA Then Remaining Amount Approved
Check TransactionID, update transaction w/QI approval for Remaining Amount (Full transaction will be more than this partial approval). QC.com will not reply to Consumer until all QI approvals arrive—separating/marking distinctly for Step 10 Settlement.

If RF=ZFGA Then Gift Amount Approved
Check Gift TransactionID, update transaction w/QI approval (already marked as PARTIAL or FULL). As each/any approval arrives, QC.com will mark them distinctly for Step 10 Settlement, and check the total approved amount versus the full transaction amount. If any of the Gifts, or the remaining amount are NOT approved, they will trigger a Transaction Canceled. So there SHOULD NOT be any ‘issue’ with waiting (something never returns) until the approved amounts equal the transaction amount. When they equal, proceed with notifications to Consumer and Merchant.
Create QC-R, RF=ZFAA, Amount=Total Approved Transaction Amount
   QC-R, QC.com, QI, null, ZFAA, null, xxx.xx, ABC123
   Send to Consumer
Create QM-R, RF=ZFAA, Amount=Total Approved Transaction Amount
   QM-R, QC.com, Consumer, null, ZFAA, null, xxx.xx, ABC123
   Send to Merchant

### Consumer Step 9: Decrypt QC-R

If RF=ZGXX then Screen notified “QC Issuer cannot confirm Gift Transaction—Canceled by QC.com—Try again and choose another Gift, if available”
Begin again at Step 3
GIFT REDEMPTION CANCELED

If RF=ZATX then Screen notified “Authentication Code error—Canceled by QC.com”
Begin again at Step 3
GIFT REDEMPTION CANCELED

If RF=ZCDX then Screen notified “Credit has been DENIED—Canceled by QC.com”
Begin again at Step 3
GIFT REDEMPTION CANCELED

If RF=ZFAA then Screen notified “Approved! Accept/Cancel?” Show the QCC and Amount, Same as Consumer Step 7 in Normal Processing

### Merchant Step 9: Decrypt QM-R, Same as Step 7 in Normal Processing

### QC.com Step 10: Decrypt QM-A, QC-A

For either RF=XXXX (Merchant and/or Consumer Canceled)
Follow Step X process for Transaction Cancelation

For both RF=ZZOK (both have Accepted)
Update QM-S Open Gift Transaction records for both accepting
Create QM-R, reply to Merchant
   QM-R, QC.com, Merchant's QB, null, ZDUN, abf, xxx.xx, ABC123
   Send to Merchant
Create QC-R, reply to Consumer
   QC-R, QC.com, Consumer's QI, null, ZDUN, abf, xxx.xx, ABC123
   Send to Consumer
If more than one approval for this same TransactionID, for each of the QI approvals marked in Step 8, send a distinct Settlement record (each amount will be different from the total—and may be from different QI's).
Create QB-T (QB Settlement record)
   QB-T, QC.com, QI's OpenID, Merchant's AuthToken, ZDUN, abf, xxx.xx, ABC123
   Send to QB
Create QI-T (QI Settlement record)
   QI-T, QC.com, QB's OpenID, Consumer's AuthToken, ZDUN, abf, xxx.xx, ABC123
   Send to QI
   No need here to wait for QB/QI reply—if unsuccessful for any reason, QM-S record will remain OPEN for periodic (24 hour recommended) audit and final settlement

QI Step 11: Decrypt QI-T—Same as Step 9 in Normal Processing

QB Step 11: Decrypt QB-T—Same as Step 9 in Normal Processing

Merchant Step 11: Decrypt QM-R—Same as Step 9 in Normal Processing

Consumer Step 11: Decrypt QC-R—Same as Step 9 in Normal Processing

QC.com Step 12: Decrypt QB-R, QI-R—Same as Step 10 in Normal Processing

QwyitCash Gift Transaction Status Check (Consumer)

Consumer's may open their QC app and check whether they have any available Gift Transactions at any time. This would simply be performing Steps 3 (as noted above), 4 and 5 in the above Gift Transaction Redemption Process; after viewing, then simply closing/canceling.

Security and Operational Benefits

QwyitCash has solved a large percentage of credit transaction problems, weaknesses, vulnerabilities and fraud; here are some of the QwyitCash solutions:
Uses a provably secure, fast, small, authentication and data security technique, QwyitTalk
   This uniquely allows 256-bit symmetric key authentication and encryption from end-to-end in real time. No other current Public or Secret key methods would allow global, billions/day transmission/transaction processing in real time, let alone at that level of security
   No other system can provide one-pass, key exchange and update, embedded authentication and child key derivation as well as the world's fastest 5 CPU cycles/byte unique-key-per-256-bit stream encryption for real time, no performance degradation processing
   The user requirements for implementation are minimal and no more complicated than today's physical card handling and use (arguably less from receipt to destruction)
   The cost of implementing QwyitTalk across any and every platform cannot be matched (free), at the end-points (Consumer smart devices, Merchant POS) and processors (QC.com, QI, QB)
   There are no capital investments required by any processors (no new servers, acceleration, bandwidth upgrades, etc.)—current equipment can be used and no unique security requirements for transmissions
   The minimal transmissions per transaction can't be matched by any system (see Appendix A)
   Seamless online addition of QwyitTalk VSU with existing online credit application for QI/QB
   Provably secure; independent review and NIST consideration
Removal of the physical card
   Eliminates physical card fraud: theft, lost, forgery, etc.
   Eliminates associated system cost
   Eliminates system complexity (hence vulnerability)
The system completely removes the need for any Merchant to store card numbers: this is one of the largest fraud areas, attacking Merchants and stealing millions of cards. The ‘convenience’ of having a card on file w/a Merchant is for online credit payment, and paying w/QwyitCash online is less effort than signing in and paying with a stored card. Merchants no longer need/should store Consumer payment info
No security risk at any POS
   Merchant QCC is for input—if someone attempts to use the Code instead of the intended Consumer, they will either pay, or the transaction wouldn't complete
   Consumer PIN entry only forms the keys in memory during transmission sending/receiving (reading), they are only live for micro-seconds. The PIN is only alive during the transaction and would need to be re-entered for another transaction; it is easily removed by either canceling, quitting the QC app or powering off the device (as well as auto time out after X seconds whether the transaction has completed or not)
All QC participants have a unified, simplified, transaction balance with equal security risk

PIN Stealth

QwyitCash has eliminated the security threat of ‘the lost/stolen physical credit card’, as a QC-enabled smart device holds only the PIN-secured versions of all keys, AuthTokens and any associated secured data; public, open data such as QI connectivity instructions, OpenIDs, etc. need no protection.

There is nothing anyone can do without knowing the PIN—stealing a device and coercing the Consumer to give up the PIN will enable use of the device for illegitimate purchases. This vulnerability will never be removed by any system; but is handled by the same credit protections that currently exist for fraudulent physical card transactions. It should also be noted that halting use of an illegitimate QC device can happen at two different transaction process locations: QC.com (stopping any transactions by invalidating/revoking the QC keys) and the QI (invalidating/revoking the associated AuthToken). Any trouble call into QC will reach both parties.

The only remaining serious threat to QwyitCash is the ‘cloned device’; e.g., malware installed (somehow/anyway) on a device to send the keylogged/mouse-click/screen captured/trapped PIN and then-easily decrypted credentials to an attacker, who will then be able to perform illegitimate (but real) transactions. There are several points to be made in this regard:
The amount of fraud committed this way is miniscule compared to what QwyitCash has stopped in its implementation; and account ‘alerts’ sent upon any transaction stops this fraud after only a single use. These alerts are commonplace on credit accounts and would be available in QC.
It is a no-sum, forever escalating battle to stop this type of attack
   Physically Unclonable Functions (PUFs), and other hardware advances, some existing, others envisioned, are specifically targeted to solving this problem: when QC is a majority of the type of transaction processing, these systems would become more prevalent and the threat eliminated
   There are ways to prevent this, using QwyitTalk primitives and existing unique identifiers of any device (IMEI, ICCID, IMSI, MSISDN, etc.)—with the assumption that the attack is performed post-initial setup. But—this requires more user steps and interaction
   There are always other dual-channel techniques that stop and/or lessen this vulnerability (2-factor (SMS, email) notification, multi-factor, etc.), yet these also add user steps and some are vulnerable to attack themselves
The end result is that the Risk/Reward scenario of malware-sending QC attacks can—and certainly would be—seriously addressed if/when it ever rose to the level of a serious problem

QwyitCash's PIN encryption at initial registration and at every transaction (and after X second timeout):

Givens:
PIN, 6 digits minimally, 8 ideally, 7 satisfactorily—is randomly created by the QC app at initialization
   New PIN can be created at any time by running Setup→New PIN
All AuthTokens, QC.com QwyitTalk communication keys and any other application-related digital information that may be required outside of the QC processes, are stored in a single area/file after PIN encrypted, uniquely identified

Encryption Process:
PIN is entered/clicked by Consumer
A random 256-bit 64 hexadecimal character salt/IV is created (called the QC Seed, QCS)—length equals the QC.com communication key lengths (MQK, MEK) set by the system
The PIN (Offset Key) and QCS (Value Key) are run through the QwyitTalk PDAF, resulting in a 256-bit 64 hex char Seed Key (result length dependent on QCS length, dependent on MQK/MEK length)
The QCS (Offset Key) and Seed Key (Value Key) are run through the QwyitTalk PDAF, resulting in a 256-bit 64 hex char Encryption Key (result length dependent on QCS length, dependent on MQK/MEK length)
The Encryption Key and each to-be-secured value (AuthToken, MQK, MEK) are run through the QwyitTalk MOD16 function, resulting in the PIN-encrypted QC values
Encrypted values are stored as above; the QCS is openly stored

Decryption Process:
PIN is entered/clicked by Consumer
PIN and QCS in PDAF, resulting in Seed Key (same as encryption)
QCS and Seed Key in PDAF, resulting in Encryption Key (same as encryption)
Encryption Key and PIN-encrypted Key in MOD16D to reveal plaintext Key (token, etc.) The QCS and stored PIN-encrypted values may be changed/updated as per system recommendations (which may be dependent on Consumer device types, usage amounts, etc.). The values are updated whenever a PIN is changed. The open key values are never stored anywhere except temporary memory, and deleted upon every transmission creation and send. This is at most 4 times per transaction (Gift processing, 3 in all others) and takes only a few micro seconds to perform; real time processing without any performance degradation, regardless of Consumer device capabilities.

The security of this encryption is based on QwyitTalk's underdetermined equation sets; it is unsolvable and therefore unbreakable. And there are only N tries out of the >16,777,216 keys (6 hex-digit PINs minimally) before lockout. It should be noted that it would be sufficient to simply MOD16 add the PIN repeatedly throughout the length of the Keys (a simply PIN offset) without any need for the QCS and the PDAF steps, and the security of the QwyitTalk system would be identical. The only reason for the dual step is on the human-error chance that one of the keys is somehow given out, the others remain secure through the dual one-way PDAFs—as there is more than one PIN upon a dictionary attack of the other same-PIN-encrypted values that will yield the now-known key, leaving the others still secure (the chances of guessing the right one are less than the 16.7M original set, but still sufficient to make the effort of somehow stealing a single key not worthwhile. Under this attack, the small size of the PIN is an asset!)

QwyitCash Summary

QwyitCash provides more security in a streamlined transaction process than any current deferred net settlement system. The removal of the physical credit card restores the proper risk balance to all participants and performs processing in real time, faster than any current system. QwyitCash relies on QwyitTalk secure authentication and encryption security communications, based on the provably secure mathematics of underdetermined systems of equations, which are maintained everywhere throughout the QwyitCash transaction process.

Credit Card Processing Comparison to QwyitCash

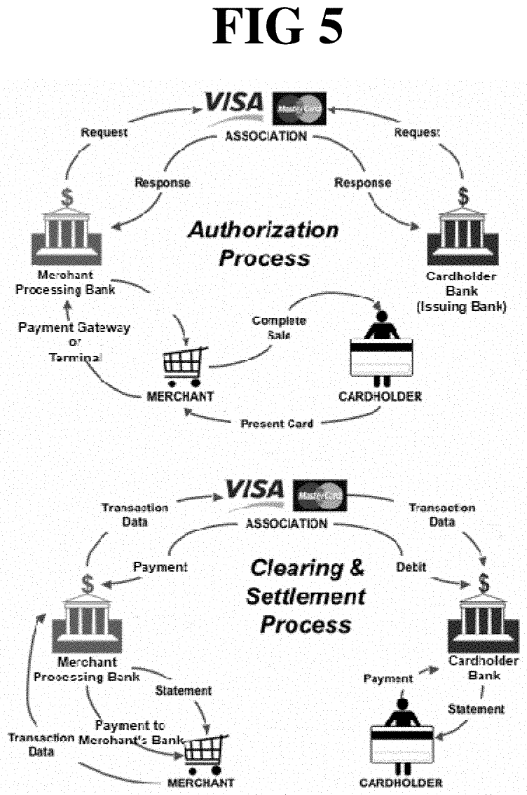

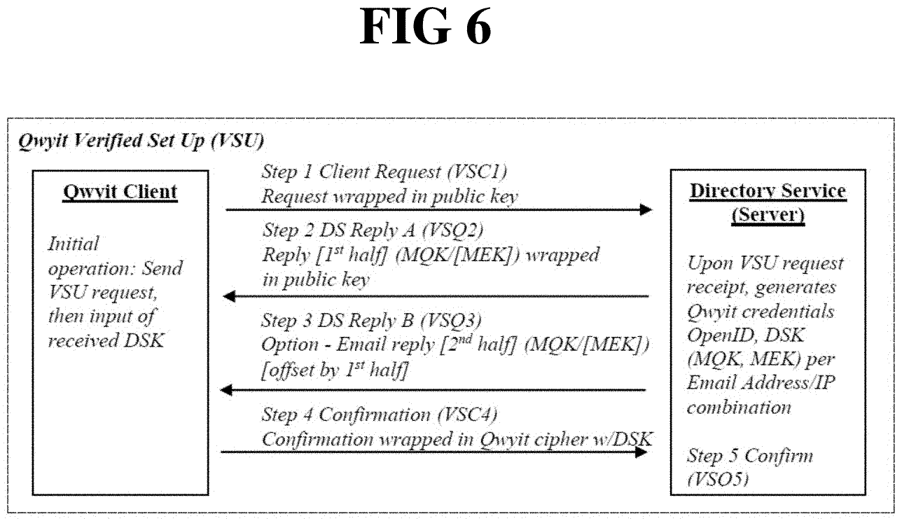

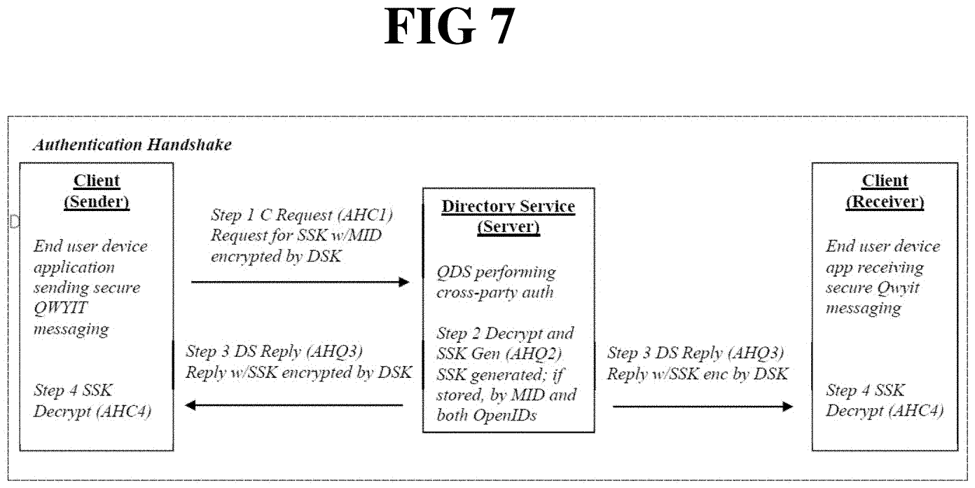

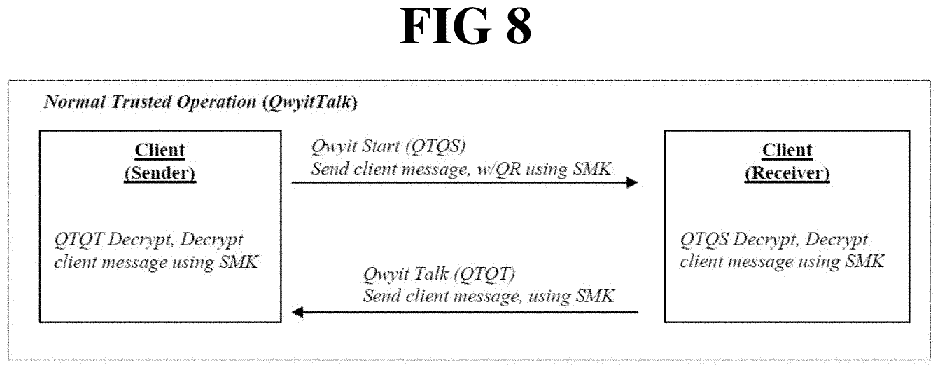

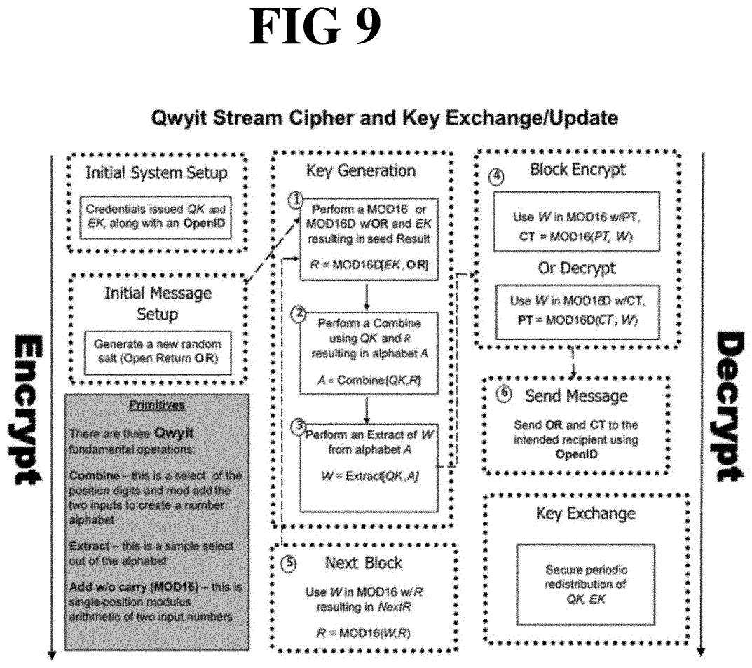

FIG. 5 depicts a picture of the transaction processing for approval and settlement of the two major credit card associations, Visa® and MasterCard®. The QwyitCash processing network is considerably streamlined in comparison, as well as more secure, as the steps below require multiple transmissions. For instance, that single line for the “Payment Gateway or Terminal” when using EMV ‘smart payment cards’ has 12 sections, with multiple transmissions per section! That single line is more steps than the entire QwyitCash transmission process!

What is claimed is:

1. A method for providing and using credit comprising:
a) registering an issuer using a central server that issues electronically to the issuer a issuer open identification value, a first issuer master key and a second issuer master key;
b) registering a bank using the central server that issues electronically to the bank a bank open identification value, a first bank master key and a second bank master key;
c) registering a consumer by an issuer webserver operating an issuer website for the issuer, receiving from the consumer a consumer personal identifier value and storing the consumer personal identifier value in association with a consumer record for the consumer in a cash issuer database coupled to the issuer webserver;
d) providing electronically a consumer cash application to a consumer computing device of the consumer after registration of the consumer;
e) storing, upon execution of the consumer cash application on the consumer computing device, the issuer website as a choice in the consumer cash application;
f) creating by the issuer webserver a consumer authentication token, a consumer open identification value, a first consumer master key and a second consumer master key;
g) transmitting electronically the consumer authentication token, the first consumer master key and the second consumer master key to the consumer cash application and to the central server;
h) receiving a personal identification number (PIN) by the consumer cash application, and encrypting by the consumer cash application the consumer authentication token, the first consumer master key and the second consumer master key using the PIN and storing encrypted versions of the consumer authentication token, the first consumer master key and the second consumer master key in a consumer storage on the consumer computing device;
i) publicly listing the consumer on a system website using the consumer open identification value and the consumer personal identifier;
j) registering a merchant by a bank webserver operating a bank website, receiving from the merchant a merchant personal identifier value and storing the merchant personal identifier value in association with a merchant record for the merchant in a bank database coupled to the bank webserver;
k) providing electronically a merchant application to a merchant computer of the merchant after registration of the merchant;
l) storing, upon execution of the merchant application on a merchant computer, the bank website as a default settlement bank in the merchant application;
m) creating by the bank webserver a merchant authentication token, a merchant open identification value, a first merchant master key and a second merchant master key;
n) transmitting electronically the merchant authentication token, the first merchant master key and the second merchant master key to the merchant application and the central server;
o) receiving a personal identification number (PIN) by the merchant application, and encrypting by the merchant application the merchant authentication token, the first merchant master key and the second merchant master key using the PIN and storing encrypted versions of the merchant authentication token, the first merchant master key and the second merchant master key in a merchant storage on the merchant computer; and
p) publicly listing the merchant on the cash system website using the merchant open identification value and the merchant personal identifier.
